(19) United States
(12) Patent Application Publication
(10) Pub. No.: US 2026/0180838 A1
(43) Pub. Date: Jun. 25, 2026

(54) LOW-COMPLEXITY METHOD FOR SOFT-OUTPUT DETECTION OF AMPLITUDE PHASE SHIFT KEYING MODULATED SIGNALS IN WIRELESS COMMUNICATIONS AND SYSTEM THEREOF, AND NON-TRANSITORY STORAGE MEDIUM

(71) Applicant: NATIONAL CHUNG CHENG UNIVERSITY, CHIAYI (TW)

(72) Inventors: Tsung-Hsien LIU, Chiayi County (TW); Jing-Hong HUANG, Changhua County (TW); Don-Lin YANG, Taoyuan City (TW)

(21) Appl. No.: 19/304,574

(22) Filed: Aug. 19, 2025

(30) Foreign Application Priority Data
Dec. 19, 2024 (TW) 113149735

(51) Int. Cl. H04L 27/02; H04L 27/34

(52) U.S. Cl. CPC H04L 27/02; H04L 27/3405; H04L 27/3483

(57) ABSTRACT

A low-complexity method for soft-output detection of Amplitude Phase Shift Keying (APSK) modulated signals in wireless communications includes partitioning and ordering all APSK constellation points into rings of ordered Phase Shift Keying (PSK) constellation points; computing a distance squared between a first constellation point of the ordered PSK constellation points of each ring and a received signal according to coordinates of the constellation points and the received signal, and finding the first nearest constellation point corresponding to the smallest distance squared, and determining a maximum log-likelihood ratio constellation point label according to the first nearest constellation point; performing an iterative search strategy to search over the ordered irregular PSK constellation points, and finding a smallest corresponding distance squared and computing a log-likelihood ratio corresponding to each bit of a bit data. The bit data corresponds to the received signal.

### RELATED APPLICATIONS

This application claims priority to Taiwan Application Serial Number 113149735, filed Dec. 19, 2024, which is herein incorporated by reference.

### BACKGROUND

### Technical Field

The present disclosure relates to a low-complexity method for soft-output detection in wireless communications and a system thereof, and a non-transitory storage medium. More particularly, the present disclosure relates to a low-complexity method for soft-output detection of Amplitude Phase Shift Keying (APSK) modulated signals in wireless communications and a system thereof, and a non-transitory storage medium.

### Description of Related Art

The future sixth-generation (6G) communication network is expected to integrate the satellite communication into the terrestrial network to provide seamless, high-capacity, and reliable communication services around the globe. Compared with the maturity of the fifth-generation (5G) ground-based communication technology, the 6G communication is focus on (low-orbit) satellite communication. The satellite communication environment is special. Currently, the main independent (low-orbit) satellite communication companies are Digital Television Broadcasting, Space X, One Web, etc. The technical specifications are mainly based on the Digital Video Broadcasting Satellite Second Generation Extended (DVB-S2X) and Consultative Committee for Space Data Systems (CCSDS) standards. The core modulation technology of communication transmission utilizes APSK modulation, which is completely different from the Quadrature Amplitude Modulation-Orthogonal Frequency Division Multiplexing (QAM-OFDM) used in ground-based mobile communications. APSK modulation signals are of low peak average power ratio to allow the APSK signals to have good performance of transmitter. However, the biggest disadvantage is that the complexity of detection of receiver is very high. In recent years, the high complexity of detection of the receiver remains the biggest disadvantage of APSK satellite communication.

Therefore, a low-complexity method for soft-output detection of APSK modulated signals in wireless communications and a system thereof, and a non-transitory storage medium which are capable of greatly reducing the complexity of detection of the receiver are commercially desirable.

### SUMMARY

According to one aspect of the present disclosure, a low-complexity method for soft-output detection of Amplitude Phase Shift Keying (APSK) modulated signals in wireless communications includes configuring a processor to obtain a data set from a memory, wherein the data set includes a plurality of amplitude phase shift keying constellation point information and a received signal, the amplitude phase shift keying constellation point information respectively correspond to a plurality of amplitude phase shift keying constellation points of a constellation diagram and include a plurality of constellation point coordinates and a plurality of constellation point labels corresponding to the constellation point coordinates, and the received signal includes a signal coordinate; configuring the processor to partition the amplitude phase shift keying constellation points into a plurality of concentric rings and order a plurality of phase shift keying constellation points of each of the concentric rings to generate a plurality of ordered phase shift keying constellation points; configuring the processor to compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point; configuring the processor to perform an iterative search strategy, wherein the iterative search strategy includes sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and configuring the processor to compute a log-likelihood ratio corresponding to each bit of a bit data, wherein the bit data corresponds to the received signal.

According to another aspect of the present disclosure, a low-complexity system for soft-output detection of Amplitude Phase Shift Keying (APSK) modulated signals in wireless communications includes a receiving end. The receiving end is configured to receive a received signal, and includes a memory and a processor. The memory stores a data set. The data set includes a plurality of amplitude phase shift keying constellation point information and the received signal, the amplitude phase shift keying constellation point information respectively correspond to a plurality of amplitude phase shift keying constellation points of a constellation diagram and include a plurality of constellation point coordinates and a plurality of constellation point labels corresponding to the constellation point coordinates, and the received signal includes a signal coordinate. The processor is electrically connected to the memory and obtains the data set from the memory. The processor is configured to partition the amplitude phase shift keying constellation points into a plurality of concentric rings, and order a plurality of phase shift keying constellation points of each of the concentric rings to generate a plurality of ordered phase shift keying constellation points; compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point; perform an iterative search strategy, wherein the iterative search strategy includes sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and compute a log-likelihood ratio corresponding to each bit of a bit data, wherein the bit data corresponds to the received signal.

According to further another aspect of the present disclosure, a non-transitory storage medium having instructions therein, when executed, causing a processor to perform a low-complexity method for soft-output detection of Amplitude Phase Shift Keying (APSK) modulated signals in wireless communications, and the low-complexity method for soft-output detection of APSK modulated signals in wireless communications includes configuring the processor to obtain a data set from a memory, wherein the data set includes a plurality of amplitude phase shift keying constellation point information and a received signal, the amplitude phase shift keying constellation point information respectively correspond to a plurality of amplitude phase shift keying constellation points of a constellation diagram and include a plurality of constellation point coordinates and a plurality of constellation point labels corresponding to the constellation point coordinates, and the received signal includes a signal coordinate; configuring the processor to partition the amplitude phase shift keying constellation points into a plurality of concentric rings and order a plurality of phase shift keying constellation points of each of the concentric rings to generate a plurality of ordered phase shift keying constellation points; configuring the processor to compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point; configuring the processor to perform an iterative search strategy, wherein the iterative search strategy includes sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and configuring the processor to compute a log-likelihood ratio corresponding to each bit of a bit data, wherein the bit data corresponds to the received signal.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a coded modulation system according to a first embodiment of the present disclosure.

FIG. 2 shows a schematic view of a low-complexity system for soft-output detection of Amplitude Phase Shift Keying (APSK) modulated signals in wireless communications according to a second embodiment of the present disclosure.

FIG. 3 shows a flow chart of a low-complexity method for soft-output detection of APSK modulated signals in wireless communications according to a third embodiment of the present disclosure.

FIG. 4 shows a schematic view of a distance squared between a point A or D on the x-axis and an arbitrary point B on a circle according to the present disclosure.

FIG. 5 shows a schematic view of an alternatively clockwise and counterclockwise operation of the present disclosure.

FIG. 6 shows a schematic view of constellation points traversed by the low-complexity method for soft-output detection of APSK modulated signals in wireless communications of FIG. 3 for a 16-APSK received signal.

FIG. 7 is a schematic view of constellation points traversed by the low-complexity method for soft-output detection of APSK modulated signals in wireless communications of FIG. 3 for another 16-APSK received signal.

FIG. 8 shows a schematic view of constellation points traversed by the low-complexity method for soft-output detection of APSK modulated signals in wireless communications of FIG. 3 for a 32-APSK received signal.

FIG. 9 shows a schematic view of constellation points traversed by the low-complexity method for soft-output detection of APSK modulated signals in wireless communications of FIG. 3 for a 64-APSK received signal.

FIG. 10 shows a schematic view of constellation points traversed by the low-complexity method for soft-output detection of APSK modulated signals in wireless communications of FIG. 3 for another 64-APSK received signal.

### DETAILED DESCRIPTION

The embodiment will be described with the drawings. For clarity, some practical details will be described below. However, it should be noted that the present disclosure should not be limited by the practical details, that is, in some embodiment, the practical details are unnecessary. In addition, for simplifying the drawings, some conventional structures and elements will be simply illustrated, and repeated elements may be represented by the same labels.

It will be understood that when an element (or unit, module) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

The Digital Video Broadcasting Satellite Second Generation Extended (DVB-S2X) was established by the European Telecommunications Standards Institute (ETSI) with the goal of providing efficient satellite communication. Compared to the Digital Video Broadcasting Satellite Second Generation (DVB-S2) Standard, DVB-S2X adopts more advanced modulation techniques, enabling higher transmission rates to support higher resolution and other demands. The use of Amplitude and Phase Shift Keying (APSK) in DVB-S2X results in a lower Peak-to-Average Power Ratio (PAPR) compared to conventional Quadrature Amplitude Modulation (QAM), making it more effective in countering the nonlinearities of satellite communication power amplifiers. The maximum log-likelihood maximum a posteriori probability (max-log-MAP) detector requires to compute the distance squared between the received signal and each APSK constellation point for the extrinsic bit Log-Likelihood Ratio (LLR) information. The algorithm of the present disclosure can partition and order all the APSK constellation points into rings of ordered Phase Shift Keying (PSK) constellation points, and apply the iterative search strategies to search over the PSK constellation points. Based on this algorithm, a soft-output detector applicable to 16-APSK, 32-APSK and 64-APSK is implemented.

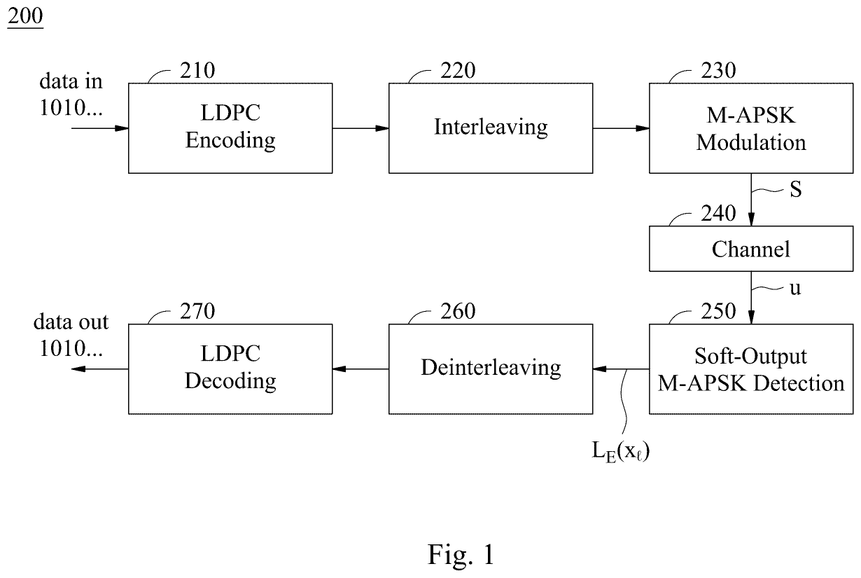

Reference is made to FIG. 1. FIG. 1 shows a schematic view of a coded modulation system 200 according to a first embodiment of the present disclosure. The coded modulation system 200 includes a Low Density Parity Check (LDPC) encoding 210, an interleaving 220, an M-APSK modulation 230, a channel 240, a soft-output M-APSK detection 250, a deinterleaving 260 and an LDPC decoding 270. The LDPC encoding 210, the interleaving 220, the M-APSK modulation 230, the channel 240, the soft-output M-APSK detection 250, the deinterleaving 260 and the LDPC decoding 270 are connected in sequence. An input data (e.g., 1010 . . . ) is inputted to the LDPC encoding 210, and passed through the LDPC encoding 210, the interleaving 220 and the M-APSK modulation 230 to generate a constellation signal S. The constellation signal S is inputted to the channel 240 to generate a received signal u, and the received signal u is inputted to the soft-output M-APSK detection 250 to generate a Log-Likelihood Ratio (LLR) L_{E}(xₗ). The log-likelihood ratio L_{E}(xₗ) is inputted to the deinterleaving 260, and passed through the deinterleaving 260 and the LDPC decoding 270 to generate an output data (e.g., 1010 . . . ). [symbol] is a positive integer, xₗ represents a bit data corresponding to the received signal u. In other embodiments, the present disclosure can utilize together with any error correction code, such as a turbo code, but the present disclosure is not limited thereto.

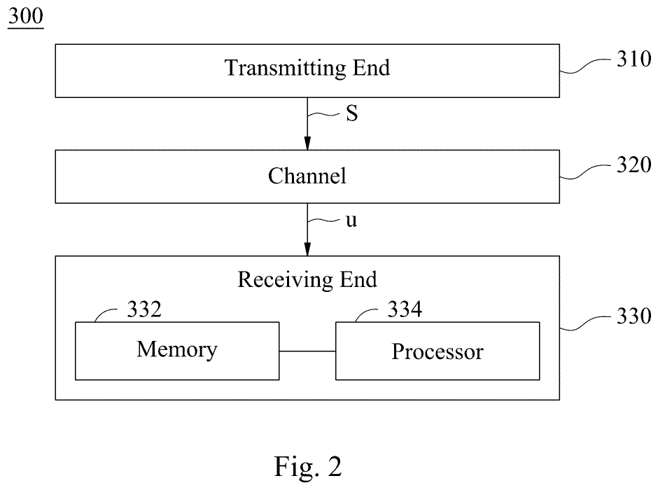

Reference is made to FIGS. 1 and 2. FIG. 2 shows a schematic view of a low-complexity system 300 for soft-output detection of Amplitude Phase Shift Keying (APSK) modulated signals in wireless communications according to a second embodiment of the present disclosure. The low-complexity system 300 for soft-output detection of APSK modulated signals in wireless communications includes a transmitting end 310, a channel 320 and a receiving end 330. The channel 320 is connected between the transmitting end 310 and the receiving end 330. The input data is inputted to the transmitting end 310 to generate the constellation signal S. The constellation signal S is inputted to the channel 240 to generate the received signal u. The received signal u is inputted to the receiving end 330 to generate the output data. The transmitting end 310 may correspond to the LDPC encoding 210, the interleaving 220 and the M-APSK modulation 230 of FIG. 1. The channel 320 may correspond to the channel 240 of FIG. 1. The receiving end 330 may correspond to the soft-output M-APSK detection 250, the deinterleaving 260 and the LDPC decoding 270 of FIG. 1.

The receiving end 330 includes a memory 332 and a processor 334. The memory 332 stores a data set. The data set includes a plurality of amplitude phase shift keying constellation point information and the received signal u. The amplitude phase shift keying constellation point information respectively correspond to a plurality of amplitude phase shift keying constellation points of a constellation diagram and include a plurality of constellation point coordinates and a plurality of constellation point labels corresponding to the constellation point coordinates. The amplitude phase shift keying constellation point information also correspond to the constellation signal S. The received signal u includes a signal coordinate. In one embodiment, the receiving end 330 may be a wireless receiver that is compliant with DVB-S2X and CCSDS standards, but the present disclosure is not limited thereto.

The processor 334 is electrically connected to the memory 332 and obtains the data set from the memory 332. The processor 334 is configured to perform following operations: (1) partition the amplitude phase shift keying constellation points into a plurality of concentric rings, and order a plurality of phase shift keying constellation points of each of the concentric rings to generate a plurality of ordered phase shift keying constellation points; (2) compute a distance squared between a first constellation point of the ordered phase shift keying constellation points of each of the concentric rings and the received signal u according to the constellation point coordinates and the signal coordinate to obtain a plurality of the distances squared between a plurality of the first constellation points of the concentric rings (all of the concentric rings) and the received signal u, find a first nearest constellation point corresponding to a smallest one of the distances squared, and determine a maximum log-likelihood ratio constellation point label according to the first nearest constellation point; (3) perform an iterative search strategy, wherein the iterative search strategy includes sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal u; and (4) compute a log-likelihood ratio L_{E}(xₗ) corresponding to each bit of a bit data xₗ, wherein the bit data xₗ corresponds to the received signal u.

The memory 332 may include a Random Access Memory (RAM) or another type of dynamic storage device that may store information and instructions for execution by the processor 334. The processor 334 may include any type of processor, microprocessor, Central Processing Unit (CPU), computer, mobile device processor, cloud processor or other high-performance computing processor. The processor 334 may include a single device (e.g., a single core) and/or a group of devices (e.g., multi-core). The present disclosure is not limited thereto.

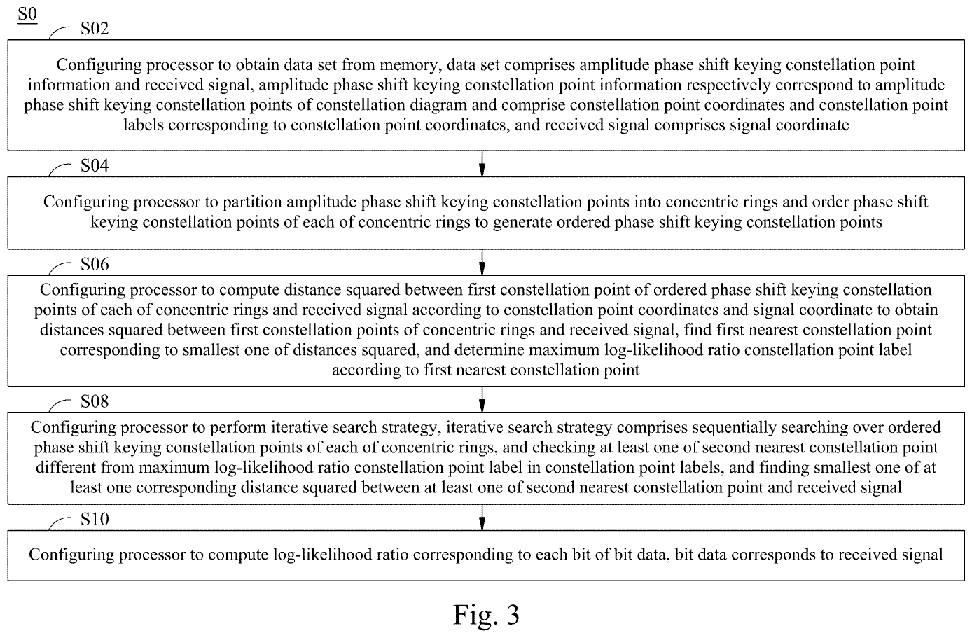

Reference is made to FIGS. 1, 2 and 3. FIG. 3 shows a flow chart of a low-complexity method S0 for soft-output detection of APSK modulated signals in wireless communications according to a third embodiment of the present disclosure. The low-complexity method S0 for soft-output detection of APSK modulated signals in wireless communications is applied to the coded modulation system 200 in FIG. 1 and the low-complexity system 300 for soft-output detection of APSK modulated signals in wireless communications in FIG. 2. The low-complexity method S0 for soft-output detection of APSK modulated signals in wireless communications includes perform a plurality of steps S02, S04, S06, S08, S10. The steps S02, S04, S06, S08, S10 are performed in sequence.

The step S02 includes configuring a processor 334 to obtain a data set from a memory 332. The data set includes a plurality of amplitude phase shift keying constellation point information and a received signal u. The amplitude phase shift keying constellation point information respectively correspond to a plurality of amplitude phase shift keying constellation points of a constellation diagram and include a plurality of constellation point coordinates and a plurality of constellation point labels corresponding to the constellation point coordinates. The received signal u includes a signal coordinate.

The step S04 includes configuring the processor 334 to partition the amplitude phase shift keying constellation points into a plurality of concentric rings and order a plurality of phase shift keying constellation points of each of the concentric rings to generate a plurality of ordered phase shift keying constellation points.

The step S06 includes configuring the processor 334 to compute a distance squared between a first constellation point of the ordered phase shift keying constellation points of each of the concentric rings and the received signal u according to the constellation point coordinates and the signal coordinate to obtain a plurality of the distances squared between a plurality of the first constellation points of the concentric rings (all of the concentric rings) and the received signal u, find a first nearest constellation point corresponding to a smallest one of the distances squared, and determine a maximum log-likelihood ratio constellation point label according to the first nearest constellation point.

The step S08 includes configuring the processor 334 to perform an iterative search strategy. The iterative search strategy includes sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal u.

The step S10 includes configuring the processor 334 to compute a log-likelihood ratio L_{E}(xₗ) corresponding to each bit of a bit data xₗ, wherein the bit data xₗ corresponds to the received signal u.

Therefore, the coded modulation system 200, the low-complexity system 300 for soft-output detection of APSK modulated signals in wireless communications and the low-complexity method S0 for soft-output detection of APSK modulated signals in wireless communications of the present disclosure can achieve the purpose of greatly reducing the computational complexity. Compared with conventional detection methods, the present disclosure can achieve exactly the max-log-MAP detection, requires very low computational complexity, and is able to detect APSK signals modulated from the APSK constellation with arbitrary parameters (arbitrary ring radii, arbitrary phase offsets, arbitrary number of constellation points, arbitrary labeling).

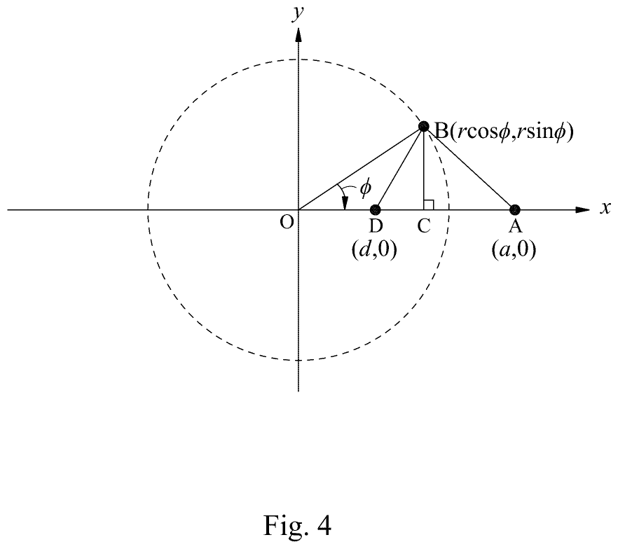

Reference is made to FIGS. 1 and 4. FIG. 4 shows a schematic view of a distance squared between a point A or D on the x-axis and an arbitrary point B on a circle according to the present disclosure. In FIG. 4, “x” represents the x-axis, and “y” represents the y-axis. In order to develop an algorithm for the soft-output M-APSK detection 250 with low-complexity, the present disclosure introduces the following Lemma 1. Lemma 1: Consider an xy coordinate system and a circle with radius rand centered at an origin O, as shown in FIG. 4. Let point B be an arbitrary point on the circle with polar coordinates (r, φ), where −π<φ<π. Points A and D are on the x-axis with Cartesian coordinates (a, 0) and (d, 0), where a>d>0. Then, the Euclidean distance squared |A̅B̅|² between points A and B and the Euclidean distance squared |B̅D̅|² between points B and D both increase as φ increases from 0 to π or as φ decreases from 0 to −π. Points A and D are located to the right and left of point C, respectively.

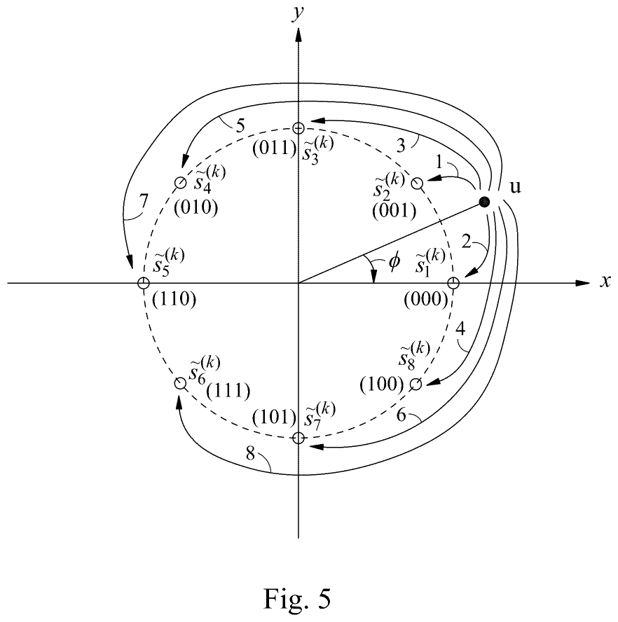

Reference is made to FIGS. 1, 2, 3, 4 and 5. FIG. 5 shows a schematic view of an alternatively clockwise and counterclockwise operation of the present disclosure. In FIG. 3, the step S04 can further include ordering the phase shift keying (PSK) constellation points of each of the concentric rings to generate the ordered PSK constellation points according to an alternatively clockwise and counterclockwise operation. The alternatively clockwise and counterclockwise operation includes ordering in a clockwise direction and a counterclockwise direction with an interleaving manner based on each of the concentric rings and the received signal u, so that the ordered PSK constellation points present an increasing trend in a plurality of rise distances squared, and the first constellation point of each of the concentric rings corresponds to a smallest one of the rise distances squared. Taking FIG. 5 as an example, FIG. 5 considers one ring of PSK constellation points from an APSK constellation diagram at a time. For the k-th ring (i.e., the k-th concentric ring), it is associated with nₖ constellation points (nₖ is equal to 8 in this embodiment). There is a distance squared between each of the PSK constellation points and the received signal u. Next, the coordinate axes are rotated in FIG. 5 such that the received signal u lies on the x-axis and plays the role of point A or D in FIG. 4. Then, the present disclosure applies the results in Lemma 1 together with the alternatively clockwise and counterclockwise operation as in FIG. 5 to sort the equally spaced PSK constellation points in the order of ascending metrics (e.g., 1, 2, 3, 4, 5, 6, 7, 8). The previous set of the PSK constellation points

$$\\ \{ {\tilde{s}}_{1}^{( k )} , {\tilde{s}}_{2}^{( k )} , {\tilde{s}}_{3}^{( k )} , {\tilde{s}}_{4}^{( k )} , {\tilde{s}}_{5}^{( k )} , {\tilde{s}}_{6}^{( k )} , {\tilde{s}}_{7}^{( k )} , {\tilde{s}}_{8}^{( k )} \}$$

is permuted to produce the new set of the ordered PSK constellation points

$$\{ {s}_{1}^{( k )} , {s}_{2}^{( k )} , {s}_{3}^{( k )} , {s}_{4}^{( k )} , {s}_{5}^{( k )} , {s}_{6}^{( k )} , {s}_{7}^{( k )} , {s}_{8}^{( k )} \} .$$

The constellation point labels of the previous set of the PSK constellation points

$$\{ {\tilde{s}}_{1}^{( k )} , {\tilde{s}}_{2}^{( k )} , {\tilde{s}}_{3}^{( k )} , {\tilde{s}}_{4}^{( k )} , {\tilde{s}}_{5}^{( k )} , {\tilde{s}}_{6}^{( k )} , {\tilde{s}}_{7}^{( k )} , {\tilde{s}}_{8}^{( k )} \}$$

are {000, 001, 011, 010, 110, 111, 101, 100}, respectively. In the embodiment,

$${s}_{1}^{( k )} = {\tilde{s}}_{2}^{( k )} , {s}_{2}^{( k )} = {\tilde{s}}_{1}^{( k )} , {s}_{3}^{( k )} = {\tilde{s}}_{3}^{( k )} , {s}_{4}^{( k )} = {\tilde{s}}_{8}^{( k )} ,$$

$${s}_{5}^{( k )} = {\tilde{s}}_{4}^{( k )} , {s}_{6}^{( k )} = {\tilde{s}}_{7}^{( k )} , {s}_{7}^{( k )} = {\tilde{s}}_{5}^{( k )} , {s}_{8}^{( k )} = {\tilde{s}}_{6}^{( k )} .$$

The first constellation point of the k-th concentric ring is

$${s}_{1}^{( k )} ,$$

and its constellation point label is “001”, but the present disclosure is not limited thereto.

In FIG. 3, the step S06 of finding the first nearest constellation point corresponding to the smallest one of the distances squared and determining the maximum log-likelihood ratio constellation point label according to the first nearest constellation point can further include finding the first nearest constellation point corresponding to the smallest one of the distances squared from the first constellation points of the concentric rings; and determining the maximum log-likelihood ratio constellation point label and a minimum distance squared according to the first nearest constellation point, and adding the maximum log-likelihood ratio constellation point label and the minimum distance squared to a maximum log-likelihood ratio parameter set. The minimum distance squared is equal to the smallest one of the distances squared.

In FIG. 3, the amplitude phase shift keying constellation points of the steps S02 and S04 are M amplitude phase shift keying (M-APSK) constellation points, and M is a power of 2. The iterative search strategy of the step S08 further includes checking the at least one of second nearest constellation point that has at least one bit inverse of the maximum log-likelihood ratio constellation point label in the constellation point labels, and finding the smallest one of the at least one corresponding distance squared between the at least one of second nearest constellation point and the received signal u, and adding the smallest one of the at least one corresponding distance squared to the maximum log-likelihood ratio parameter set. An iteration number of the iterative search strategy is less than or equal to log₂ M. In other words, the iterative search strategy is repeated N times, and N less than or equal to log₂ M.

In the low-complexity method S0 for soft-output detection of APSK modulated signals in wireless communications of the present disclosure, the first nearest constellation point, the smallest one of the distances squared, the maximum log-likelihood ratio constellation point label, the at least one of second nearest constellation point, the smallest one of the at least one corresponding distance squared, the maximum log-likelihood ratio parameter set and the log-likelihood ratio L_{E}(xₗ) are applied to the soft-output M-APSK detection 250 of the receiving end 330 to reduce a computational complexity of the soft-output M-APSK detection 250.

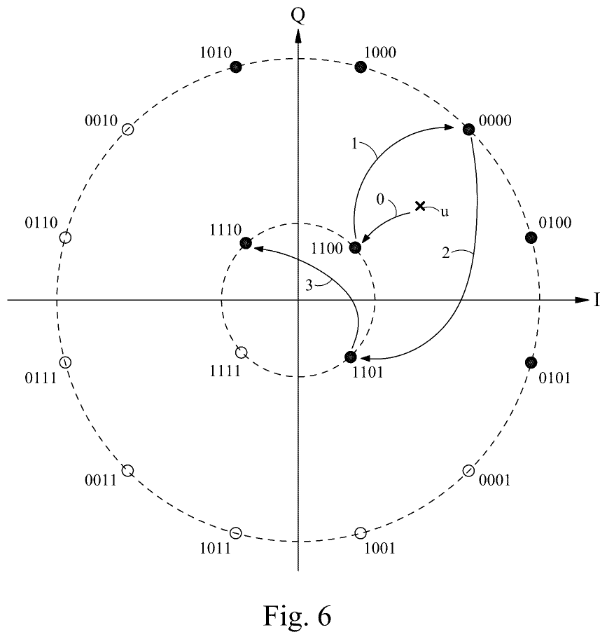

Reference is made to FIGS. 1, 2, 3, 5, 6 and Table 1. FIG. 6 shows a schematic view of constellation points traversed by the low-complexity method S0 for soft-output detection of APSK modulated signals in wireless communications of FIG. 3 for a 16-APSK received signal u (u=0.5475+0.4676j). Table 1 lists the iterative search steps and results of the iterative search strategy of FIG. 6. In FIG. 6, “I” represents a real part, and “Q” represents an imaginary part. In Table 1, “Iteration” represents an iteration number; “Traversed constellation points” represents a plurality of traversed constellation points; “inner ring” represents an inner ring; “outer ring” represents an outer ring; “Computed elements” represents a plurality of computed elements; “Index set” represents an index set; and “ [symbol] ⁽¹⁾”, “ [symbol] ⁽²⁾” and “ [symbol] ^{MAP}” represent I⁽¹⁾, I⁽²⁾ and L^{MAP}, respectively. The low-complexity method S0 for soft-output detection of APSK modulated signals in wireless communications of the present disclosure detects the 16-APSK modulated signal in FIG. 4. The received signal u with angle φ is configured to determine the ordered phase shift keying constellation points S⁽¹⁾={1100, 1101, 1110, 1111} associated with increasing metrics in the rise distances squared in the inner ring and the ordered phase shift keying constellation points S⁽²⁾={0000, 0100, 1000, 0101, 1010, 0001, 0010, 1001, 0110, 1011, 0111, 0011} associated with increasing metrics in the rise distances squared in the outer ring.

TABLE 1

| | Traversed | Traversed | | |
|---|---|---|---|---|
| | constellation | constellation | Computed | Index |
| | points in the | points in the | elements | set when |
| | inner ring | outer ring | in | iteration ends |
| Iteration | x + [symbol] ⁽¹⁾ | x + [symbol] ⁽²⁾ | [symbol] ^{MAP} | Φ |
| 0 | 1100 | 0000 | [symbol] ^{MAP}, x^{MAP} | {1, 2, 3, 4} |
| 1 | 1101 + {4} | 0000 + {1, 2} | ${λ}_{1}^{\overline{MAP}} , {λ}_{2}^{\overline{MAP}}$ | {3, 4} |
| 2 | 1101 + {4} | 0100 + Ø (skipped) 1000 + Ø (skipped) | ${λ}_{4}^{\overline{MAP}}$ | {3} |
| | | 0101 + {4} | | |
| 3 | 1110 + {3} | 0101 + Ø (skipped) 1010 + {3} | ${λ}_{3}^{\overline{MAP}}$ | 0 |

The iterative search of the iterative search strategy of the step S08 travels along the path denoted by arrows in FIG. 6 to determine the distances squared (distance metrics) and the maximum log-likelihood ratio parameter set L^{MAP}. The number beside each arrow denotes the associated iteration number. The traversed constellation points are plotted with solid dots, while the constellation points that are not traversed are plotted with circles. Among the traversed constellation points, only those constellation points pointed by arrows lead to the distances squared (distance metrics) that contribute to the maximum log-likelihood ratio parameter set L^{MAP}. Thus, only the distances squared (distance metrics) of constellation points 1100, 0000, 1101, and 1110 contribute to the maximum log-likelihood ratio parameter set L^{MAP}.

As shown in FIG. 6 and Table 1, in the 0-th iteration, the two constellation points 1100 and 0000 are the first elements of S⁽¹⁾ and S⁽²⁾, respectively. The constellation point 1100 is associated with a smaller distance squared (distance metrics). The constellation point x^{MAP}=1100 and associated distance squared λ^{MAP} are obtained. The traversed constellation point 1100 is deleted from S⁽¹⁾. In the first iteration, the candidate constellation point 0000 from S⁽²⁾ is associated with a smaller distance squared than the candidate constellation point 1101 from S⁽¹⁾. The index set associated with the constellation point 0000 is I⁽²⁾={1, 2};

$${λ}_{1}^{\overline{MAP}} and {λ}_{2}^{\overline{MAP}}$$

are obtained. The constellation point 0000 is deleted from S⁽²⁾. The bit index set for not yet computed

$${λ}_{ℓ}^{\overline{MAP}} ’ s$$

after the first iteration is φ={3, 4} as shown in the rightmost column of Table 1. In the second iteration, the constellation points 0100 and 1000 are associated with the same index set I⁽²⁾=Ø, because their 3rd and 4th bits are the same 00 and are identical to the 3rd and 4th bits of x^{MAP}=1100. These two constellation points do not contribute to new

$${λ}_{ℓ}^{\overline{MAP}} ’ s ;$$

they are skipped (or deleted) from S⁽²⁾. Then, the two candidate constellation points from S⁽¹⁾ and S⁽²⁾ are 1101 and 0101, respectively; these two candidate constellation points are also associated with the same bit index set I⁽¹⁾=I⁽²⁾{4}. The constellation point 1101 is associated with a smaller distance squared, which is assigned to

$${λ}_{4}^{\overline{MAP}} .$$

In the third iteration, the last

$${λ}_{3}^{\overline{MAP}}$$

is computed. Accordingly, it takes 3 iterations for the proposed algorithm of the present disclosure to compute log₂ 16 (i.e., M of log₂ M is equal to 16) distances squared

$${λ}_{ℓ}^{\overline{MAP}} ,$$

[symbol]

(all [symbol] ), in this embodiment.

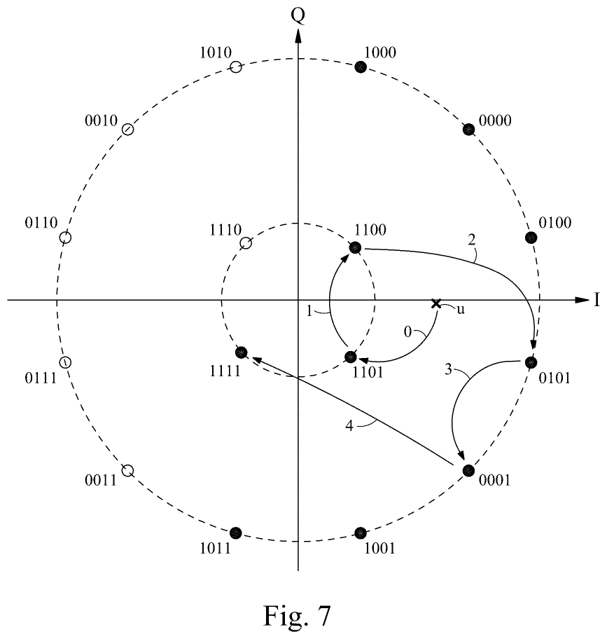

Reference is made to FIGS. 1, 2, 3, 5, 7 and Table 2. FIG. 7 is a schematic view of constellation points traversed by the low-complexity method S0 for soft-output detection of APSK modulated signals in wireless communications of FIG. 3 for another 16-APSK received signal u (u=0.5983−0.0007j). Table 2 lists the iterative search steps and results of the iterative search strategy of FIG. 7. For the another 16-APSK received signal u in FIG. 7, it takes 4 iterations for the proposed algorithm (the step S08) of the present disclosure to compute the distances squared

$${λ}_{ℓ}^{\overline{MAP}} ,$$

[symbol]

. The detailed iterative steps to obtain the maximum log-likelihood ratio parameter set L^{MAP} are provided in Table 2 for verification.

TABLE 2

| | Traversed | Traversed | | |
|---|---|---|---|---|
| | constellation | constellation | Computed | Index |
| | points in the | points in the | elements | set when |
| | inner ring | outer ring | in | iteration ends |
| Iteration | x + [symbol] ⁽¹⁾ | x + [symbol] ⁽²⁾ | [symbol] ^{MAP} | Φ |
| 0 | 1101 | 0101 | [symbol] ^{MAP}, x^{MAP} | {1, 2, 3, 4} |
| 1 | 1100 + {4} | 0101 + {1} | ${λ}_{4}^{\overline{MAP}}$ | {1, 2, 3} |
| 2 | 1111 + {3} | 0101 + {1} | ${λ}_{1}^{\overline{MAP}}$ | {2, 3] |
| 3 | 1111 + (3} | 0100 + Ø (skipped) 0001 + {2} | ${λ}_{2}^{\overline{MAP}}$ | {3} |
| 4 | 1111 + {3} | 0000 + Ø (skipped) 1001 + Ø (skipped) | ${λ}_{3}^{\overline{MAP}}$ | Ø |
| | | 1000 + Ø (skipped) | | |
| | | 1011 + {3} | | |

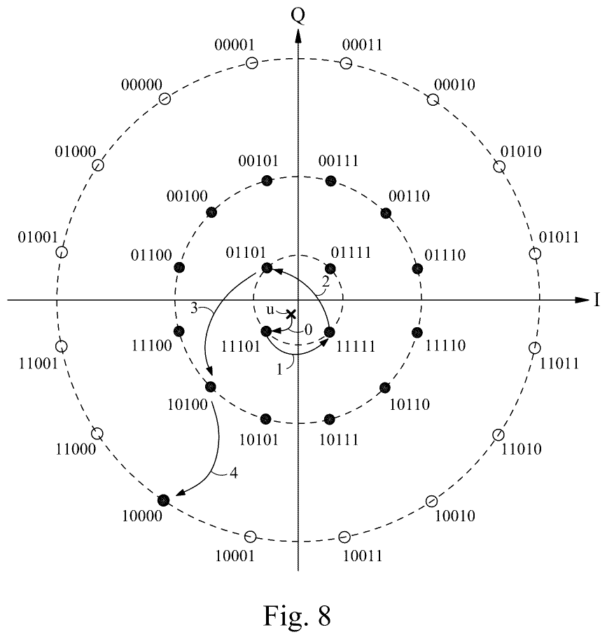

Reference is made to FIGS. 1, 2, 3, 5, 8 and Table 3. FIG. 8 shows a schematic view of constellation points traversed by the low-complexity method S0 for soft-output detection of APSK modulated signals in wireless communications of FIG. 3 for a 32-APSK received signal u (u=−0.0479−0.0765j). Table 3 lists the iterative search steps and results of the iterative search strategy of FIG. 8. For the 32-APSK received signal u in FIG. 8, it takes 4 iterations for the proposed algorithm (the step S08) of the present disclosure to compute the distances squared

$${λ}_{ℓ}^{\overline{MAP}} ,$$

[symbol]

. The detailed iterative steps to obtain the maximum log-likelihood ratio parameter set L^{MAP} are provided in Table 3 for verification.

TABLE 3

| | Traversed | Traversed | Traversed | | Index |
|---|---|---|---|---|---|
| | constellation | constellation | constellation | Computed | set when |
| | points in | points in | points in | elements | iteration |
| | ring #1 | ring #2 | ring #3 | in | ends |
| Iteration | x + [symbol] ⁽¹⁾ | x + [symbol] ⁽²⁾ | x + [symbol] ⁽³⁾ | [symbol] ^{MAP} | Φ |
| 0 | 11101 | 10100 | 10000 | [symbol] ^{MAP}, x^{MAP} | {1, 2, 3, 4, 5} |
| 1 | 11111 + {4} | 10100 + {2, 5} | 10000 + {2, 3, 5} | ${λ}_{4}^{\overline{MAP}}$ | {1, 2, 3, 5} |
| 2 | 01101 + {1} | 10100 + {2, 5} | 10000 + {2, 3, 5} | ${λ}_{1}^{\overline{MAP}}$ | {2, 3, 5} |
| 3 | 01111 + Ø | 10100 + {2, 5} | 10000 + {2, 3, 5} | ${λ}_{2}^{\overline{MAP}} , {λ}_{5}^{\overline{MAP}}$ | {3} |
| 4 | | 11100 + Ø 10101 + Ø | 10000 + {3} | ${λ}_{3}^{\overline{MAP}}$ | Ø |
| | | 01100 + Ø | | | |
| | | 10111 + Ø | | | |
| | | 00100 + Ø | | | |
| | | 10110 + Ø | | | |
| | | 00101 + Ø | | | |
| | | 11110 + Ø | | | |
| | | 00111 + Ø | | | |
| | | 01110 + Ø | | | |
| | | 00110 + Ø | | | |

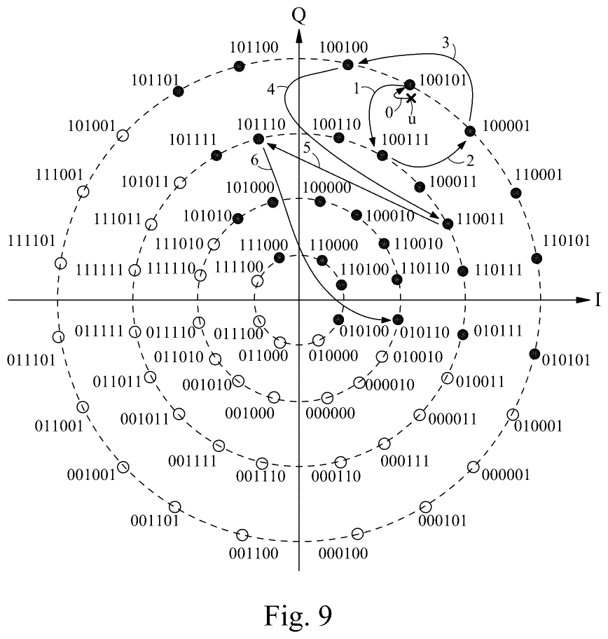

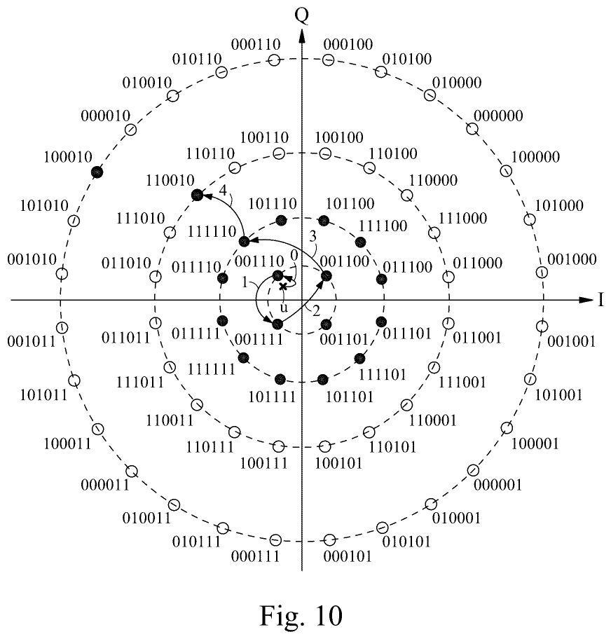

Reference is made to FIGS. 1, 2, 3, 5, 9 and 10. FIG. 9 shows a schematic view of constellation points traversed by the low-complexity method S0 for soft-output detection of APSK modulated signals in wireless communications of FIG. 3 for a 64-APSK (8+16+20+20-APSK) received signal u (u=0.6538+10.1721j). FIG. 10 shows a schematic view of constellation points traversed by the low-complexity method S0 for soft-output detection of APSK modulated signals in wireless communications of FIG. 3 for another 64-APSK (4+12+20+28-APSK) received signal u (u=−0.0892+0.0677j). For the 64-APSK received signal u in FIG. 9, it takes 6 iterations for the proposed algorithm (the step S08) of the present disclosure to compute the distances squared

$${λ}_{ℓ}^{\overline{MAP}} ,$$

[symbol]

. For the another 64-APSK received signal u in FIG. 10, it takes 4 iterations for the proposed algorithm (the step S08) of the present disclosure to compute the distances squared

$${λ}_{ℓ}^{\overline{MAP}} ,$$

[symbol]

.

As can be seen from the above, the proposed algorithm of the present disclosure is capable of detecting the 16-APSK received signals u in FIGS. 6 and 7, the 32-APSK received signal u in FIG. 8 and the 64-APSK received signals u in FIGS. 9 and 10. In other words, M of M-APSK is a power of 2, and can be 16, 32 or 64, but the present disclosure is not limited thereto. In addition, as can be seen from the above embodiment, the traversal path for the proposed algorithm of the present disclosure to determine the maximum log-likelihood ratio parameter set L^{MAP} from each received signal u appears to be irregular (i.e., the constellation signal S is an irregular M-APSK constellation signal), and depends on the location of the received signal u and APSK constellation point.

Reference is made to FIGS. 1, 2, 3, 5 and Table 4. Table 4 lists a Sorting Assisted Search (SAS) algorithm (Algorithm 1) of the present disclosure, and corresponds to the low-complexity method S0 for soft-output detection of APSK modulated signals in wireless communications of FIG. 3. In lines 1-2 of Table 4 (corresponding to the step S02), the SAS algorithm initializes the data set. In lines 4-7 of Table 4 (corresponding to the step S04), the SAS algorithm orders the constellation points of each ring for calculation in lines 9-43. In lines 9-11 of Table 4 (corresponding to the step S06), the SAS algorithm computes λ^{MAP} and x^{MAP} for calculation of the iterative search strategy in lines 12-43. In lines 12-43 of Table 4 (corresponding to the step S08), the SAS algorithm performs iteration to compute the distances squared

$${λ}_{ℓ}^{\overline{MAP}} ,$$

[symbol]

.

```
TABLE 4
Sorting assisted search algorithm (lines 1-11) of the present disclosure
  Algorithm 1: The proposed sorting assisted search
  (SAS) algorithm for the max-log-MAP detection of
  irregular M -APSK signals.
    input: received ũ, channel gain \tilde{h}, constellation [symbol] .
          noise variance N₀
    output: L_{E}( [symbol] ), [symbol]  = 1, 2, ... , log₂ M
  1 Initialize Φ as in (24) and [symbol] ^{MAP} = Ø
  2  Compute h = |\tilde{h}| and u = ũ e^{-∠}\tilde{^{h}} from \tilde{h}
  3 % The sorting stage
  4 Compute ∠u from u
  5 for k = 1 to K do
  6 |  $Compare ∠ u with angles ∠ {\tilde{s}}_{ℓ}^{( k )} , ∀ ℓ , as in ( 19 ) to$
    | determine the ordered set S(k) in (20)
  7 end
  8  % The search stage
  9 Compute λ^{MAP} and x^{MAP} as in (21) and (22),
      respectively. Add λ^{MAP} and x^{MAP} to [symbol] ^{MAP}.
10 Delete the first element of [symbol] ^{(k}^{ₘᵢₙ}⁾, where kₘᵢₙ is
      defined in (23)
11 Assign [symbol] ^{(k)} = 1, k ∈ {1, 2, ... , K} − {kₘᵢₙ} and [symbol]
      ^{(k}^{ₘᵢₙ}⁾ = 0
```

| | |
|---|---|
| Φ = {1, 2, ... , log₂ M}. | (Eq. 24) |

```
  ${s}_{1}^{( k )} = arg {min}_{s ∈ \{ {\tilde{s}}_{1}^{( k )} , … , {\tilde{s}}_{{n}_{k}}^{( k )} \}} {\vert u - hs \vert}^{2} \qquad ( Eq . 19 )$
    $= arg {min}_{s ∈ \{ {\tilde{s}}_{1}^{( k )} , … , {\tilde{s}}_{{n}_{k}}^{( k )} \}} \vert ∠ u - ∠ s \vert .$
  ${𝒮}^{( k )} = \{ {s}_{1}^{( k )} , {s}_{2}^{( k )} , … , {s}_{{n}_{k}}^{( k )} \} , k = 1 , 2 , … , K . \qquad ( Eq . 20 )$
  ${λ}^{MAP} = {min}_{s ∈ \{ {s}_{1}^{( k )} : k = 1 , 2 , … , K \}} {\vert u - hs \vert}^{2} . \qquad ( Eq . 21 )$
  ${x}^{MAP} = arg {min}_{s ∈ \{ {s}_{1}^{( k )} : k = 1 , 2 , … , K \}} {\vert u - hs \vert}^{2} . \qquad ( Eq . 22 )$
  ${k}_{min} = arg {min}_{k ∈ \{ 1 , 2 , … , K \}} {\vert u - {hs}_{1}^{( k )} \vert}^{2} . \qquad ( Eq . 23 )$
Sorting assisted search algorithm (lines 12-44) of the present disclosure
12 while Φ ≠ Ø do
13 | for k = 1 to K do
14 | | % Find next valid candidate point from [symbol] ^{(k)}
15 | | [symbol]  ^{(k)} = Ø T(*) =
16 | | while [symbol] ^{(k)} = Ø holds do
17 | | | if [symbol] ^{(k)} = Ø holds then
18 | | | | ρ^{(k)} = ∞
19 | | | else
20 | | | | Let s be the first element of [symbol] ^{(k)} and
                its equivalent bit vector be x
21 | | | | for each [symbol]  ∈ Φ do
22 | | | | |  $if {x}_{ℓ} \neq {x}_{p}^{MAP} then$
23 | | | | | | Add [symbol]  to [symbol] ^{(k)}
24 | | | | | end
25 | | | | end
26 | | | | if [symbol] ^{(k)} = Ø holds then
27 | | | | | Delete the first element of [symbol] ^{(k)}
28 | | | | | [symbol]  ^{(k)} = 0
29 | | | | else
30 | | | | | if [symbol] ^{(k)} = 0 holds then
31 | | | | | | Compute ρ^{(k)} as in (25)
32 | | | | | | [symbol]  ^{(k)} = 1
33 | | | | | end
34 | | | | end
35 | | | end
36 | | end
37 | end
38 | Compute the index kₘᵢₙ, which is computed from
        the minimum metrics ρ^{(k)}, ∀k, as in (26)
39 |  $Add those {λ}_{ℓ}^{\overline{MAP}} ' s defined in ( 27 ) to {ℒ}^{MAP}$
40 | Remove the elements of [symbol] ^{(k}^{ₘᵢₙ}⁾ from Φ
41 | Delete the first element of [symbol] ^{(k}^{ₘᵢₙ}⁾
42 | [symbol]  ^{(k}^{ₘᵢₙ}⁾ = 0
43 end
44 Compute L_{E}( [symbol] ), ∀ [symbol] , according to (14).
```

| | |
|---|---|
| ρ^{(k)} = \|u - hs\|². | (Eq. 25) |

```
  ${k}_{min} = arg {min}_{k = 1 , 2 , … , K} {ρ}^{( k )} . \qquad ( Eq . 26 )$
  ${λ}_{ℓ}^{\overline{MAP}} = {ρ}^{( {k}_{min} )} , ℓ ∈ {ℐ}^{( {k}_{min} )} . \qquad ( Eq . 27 )$
  ${L}_{E} ( {x}_{ℓ} ) = \{ \begin{matrix}\frac{1}{{N}_{o}} ( {λ}_{ℓ}^{\overline{MAP}} - {λ}^{MAP} ) , & {x}_{ℓ}^{MAP} = + 1 \\ \frac{1}{{N}_{o}} ( {λ}^{MAP} - {λ}_{ℓ}^{\overline{MAP}} ) , & {x}_{ℓ}^{MAP} = 0.\end{matrix} \qquad ( Eq . 14 )$
```

It is understood that the low-complexity method S0 for soft-output detection of APSK modulated signals in wireless communications of the present disclosure is performed by the aforementioned steps. A computer program of the present disclosure stored on a non-transitory tangible computer readable recording medium is used to perform the method described above. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like).

According to the aforementioned embodiments and examples, the advantages of the present disclosure are described as follows.

1. The present disclosure can achieve the purpose of greatly reducing the computational complexity. Compared with conventional detection methods, the present disclosure can achieve exactly the max-log-MAP detection, requires very low computational complexity, and is able to detect APSK signals modulated from the APSK constellation with arbitrary parameters (arbitrary ring radii, arbitrary phase offsets, arbitrary number of constellation points, arbitrary labeling).

2. The present disclosure can effectively reduce the complexity of detection of receiver to enable the APSK satellite receiver to have lower complexity and lower power consumption, thereby improving the performance of the APSK satellite receiver.

3. The present disclosure can be compliant with DVB-S2X and CCSDS standards, and can also be compliant with the max-log-MAP detection of all future APSK signals to solve the problem of high complexity of conventional detection of receiver. In DVB-S2X, APSK signals with 16, 32 and 64 constellation points are used, and the complexity required by the proposed algorithm of the present disclosure is only about 42%, 31% and 23% of the complexity of the conventional methods.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A low-complexity method for soft-output detection of Amplitude Phase Shift Keying (APSK) modulated signals in wireless communications, comprising:
configuring a processor to obtain a data set from a memory, wherein the data set comprises a plurality of amplitude phase shift keying constellation point information and a received signal, the amplitude phase shift keying constellation point information respectively correspond to a plurality of amplitude phase shift keying constellation points of a constellation diagram and comprise a plurality of constellation point coordinates and a plurality of constellation point labels corresponding to the constellation point coordinates, and the received signal comprises a signal coordinate;
configuring the processor to partition the amplitude phase shift keying constellation points into a plurality of concentric rings and order a plurality of phase shift keying constellation points of each of the concentric rings to generate a plurality of ordered phase shift keying constellation points;
configuring the processor to compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point;
configuring the processor to perform an iterative search strategy, wherein the iterative search strategy comprises sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and
configuring the processor to compute a log-likelihood ratio corresponding to each bit of a bit data, wherein the bit data corresponds to the received signal.

2. The low-complexity method for soft-output detection of APSK modulated signals in wireless communications of claim 1, wherein step of configuring the processor to partition the amplitude phase shift keying constellation points into the concentric rings and order the phase shift keying constellation points of each of the concentric rings to generate the ordered phase shift keying constellation points comprises:
ordering the phase shift keying constellation points of each of the concentric rings to generate the ordered phase shift keying constellation points according to an alternatively clockwise and counterclockwise operation;
wherein the alternatively clockwise and counterclockwise operation comprises ordering in a clockwise direction and a counterclockwise direction with an interleaving manner based on each of the concentric rings and the received signal, so that the ordered phase shift keying constellation points present an increasing trend in a plurality of rise distances squared, and the first constellation point of each of the concentric rings corresponds to a smallest one of the rise distances squared.

3. The low-complexity method for soft-output detection of APSK modulated signals in wireless communications of claim 2, wherein step of finding the first nearest constellation point corresponding to the smallest one of the distances squared and determining the maximum log-likelihood ratio constellation point label according to the first nearest constellation point comprises:
finding the first nearest constellation point corresponding to the smallest one of the distances squared from the first constellation points of the concentric rings; and
determining the maximum log-likelihood ratio constellation point label and a minimum distance squared according to the first nearest constellation point, and adding the maximum log-likelihood ratio constellation point label and the minimum distance squared to a maximum log-likelihood ratio parameter set;
wherein the minimum distance squared is equal to the smallest one of the distances squared.

4. The low-complexity method for soft-output detection of APSK modulated signals in wireless communications of claim 3, wherein the amplitude phase shift keying constellation points are M amplitude phase shift keying (M-APSK) constellation points, M is a power of 2, and the iterative search strategy further comprises:
checking the at least one of second nearest constellation point that has at least one bit inverse of the maximum log-likelihood ratio constellation point label in the constellation point labels, and finding the smallest one of the at least one corresponding distance squared between the at least one of second nearest constellation point and the received signal, and adding the smallest one of the at least one corresponding distance squared to the maximum log-likelihood ratio parameter set;
wherein an iteration number of the iterative search strategy is less than or equal to log₂ M.

5. The low-complexity method for soft-output detection of APSK modulated signals in wireless communications of claim 4, wherein the first nearest constellation point, the smallest one of the distances squared, the maximum log-likelihood ratio constellation point label, the at least one of second nearest constellation point, the smallest one of the at least one corresponding distance squared, the maximum log-likelihood ratio parameter set and the log-likelihood ratio are applied to a soft-output M-APSK detection of a receiving end to reduce a computational complexity of the soft-output M-APSK detection.

6. A low-complexity system for soft-output detection of Amplitude Phase Shift Keying (APSK) modulated signals in wireless communications, comprising:
a receiving end configured to receive a received signal, and comprising:
a memory storing a data set, wherein the data set comprises a plurality of amplitude phase shift keying constellation point information and the received signal, the amplitude phase shift keying constellation point information respectively correspond to a plurality of amplitude phase shift keying constellation points of a constellation diagram and comprise a plurality of constellation point coordinates and a plurality of constellation point labels corresponding to the constellation point coordinates, and the received signal comprises a signal coordinate; and
a processor electrically connected to the memory and obtaining the data set from the memory, wherein the processor is configured to:
partition the amplitude phase shift keying constellation points into a plurality of concentric rings, and order a plurality of phase shift keying constellation points of each of the concentric rings to generate a plurality of ordered phase shift keying constellation points;
compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point;
perform an iterative search strategy, wherein the iterative search strategy comprises sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and
compute a log-likelihood ratio corresponding to each bit of a bit data, wherein the bit data corresponds to the received signal.

7. The low-complexity system for soft-output detection of APSK modulated signals in wireless communications of claim 6, wherein operation of configuring the processor to partition the amplitude phase shift keying constellation points into the concentric rings and order the phase shift keying constellation points of each of the concentric rings to generate the ordered phase shift keying constellation points comprises:
ordering the phase shift keying constellation points of each of the concentric rings to generate the ordered phase shift keying constellation points according to an alternatively clockwise and counterclockwise operation;
wherein the alternatively clockwise and counterclockwise operation comprises ordering in a clockwise direction and a counterclockwise direction with an interleaving manner based on each of the concentric rings and the received signal, so that the ordered phase shift keying constellation points present an increasing trend in a plurality of rise distances squared, and the first constellation point of each of the concentric rings corresponds to a smallest one of the rise distances squared.

8. The low-complexity system for soft-output detection of APSK modulated signals in wireless communications of claim 7, wherein operation of finding the first nearest constellation point corresponding to the smallest one of the distances squared and determining the maximum log-likelihood ratio constellation point label according to the first nearest constellation point comprises:
finding the first nearest constellation point corresponding to the smallest one of the distances squared from the first constellation points of the concentric rings; and
determining the maximum log-likelihood ratio constellation point label and a minimum distance squared according to the first nearest constellation point, and adding the maximum log-likelihood ratio constellation point label and the minimum distance squared to a maximum log-likelihood ratio parameter set;
wherein the minimum distance squared is equal to the smallest one of the distances squared.

9. The low-complexity system for soft-output detection of APSK modulated signals in wireless communications of claim 8, wherein the amplitude phase shift keying constellation points are M amplitude phase shift keying (M-APSK) constellation points, M is a power of 2, and the iterative search strategy further comprises:
checking the at least one of second nearest constellation point that has at least one bit inverse of the maximum log-likelihood ratio constellation point label in the constellation point labels, and finding the smallest one of the at least one corresponding distance squared between the at least one of second nearest constellation point and the received signal, and adding the smallest one of the at least one corresponding distance squared to the maximum log-likelihood ratio parameter set;
wherein an iteration number of the iterative search strategy is less than or equal to log₂ M.

10. The low-complexity system for soft-output detection of APSK modulated signals in wireless communications of claim 9, wherein the first nearest constellation point, the smallest one of the distances squared, the maximum log-likelihood ratio constellation point label, the at least one of second nearest constellation point, the smallest one of the at least one corresponding distance squared, the maximum log-likelihood ratio parameter set and the log-likelihood ratio are applied to a soft-output M-APSK detection of a receiving end to reduce a computational complexity of the soft-output M-APSK detection.

11. A non-transitory storage medium having instructions therein, when executed, causing a processor to perform a low-complexity method for soft-output detection of Amplitude Phase Shift Keying (APSK) modulated signals in wireless communications, and the low-complexity method for soft-output detection of APSK modulated signals in wireless communications comprising:
configuring the processor to obtain a data set from a memory, wherein the data set comprises a plurality of amplitude phase shift keying constellation point information and a received signal, the amplitude phase shift keying constellation point information respectively correspond to a plurality of amplitude phase shift keying constellation points of a constellation diagram and comprise a plurality of constellation point coordinates and a plurality of constellation point labels corresponding to the constellation point coordinates, and the received signal comprises a signal coordinate;
configuring the processor to partition the amplitude phase shift keying constellation points into a plurality of concentric rings and order a plurality of phase shift keying constellation points of each of the concentric rings to generate a plurality of ordered phase shift keying constellation points;
configuring the processor to compute a distance squared between a first constellation point of the ordered phase shift keying constellation points of each of the concentric rings and the received signal according to the constellation point coordinates and the signal coordinate to obtain a plurality of the distances squared between a plurality of the first constellation points of the concentric rings and the received signal, find a first nearest constellation point corresponding to a smallest one of the distances squared, and determine a maximum log-likelihood ratio constellation point label according to the first nearest constellation point;
configuring the processor to perform an iterative search strategy, wherein the iterative search strategy comprises sequentially searching over the ordered phase shift keying constellation points of each of the concentric rings, and checking at least one of second nearest constellation point different from the maximum log-likelihood ratio constellation point label in the constellation point labels, and finding a smallest one of at least one corresponding distance squared between the at least one of second nearest constellation point and the received signal; and
configuring the processor to compute a log-likelihood ratio corresponding to each bit of a bit data, wherein the bit data corresponds to the received signal.

12. The non-transitory storage medium of claim 11, wherein step of configuring the processor to partition the amplitude phase shift keying constellation points into the concentric rings and order the phase shift keying constellation points of each of the concentric rings to generate the ordered phase shift keying constellation points comprises:
ordering the phase shift keying constellation points of each of the concentric rings to generate the ordered phase shift keying constellation points according to an alternatively clockwise and counterclockwise operation;
wherein the alternatively clockwise and counterclockwise operation comprises ordering in a clockwise direction and a counterclockwise direction with an interleaving manner based on each of the concentric rings and the received signal, so that the ordered phase shift keying constellation points present an increasing trend in a plurality of rise distances squared, and the first constellation point of each of the concentric rings corresponds to a smallest one of the rise distances squared.

13. The non-transitory storage medium of claim 12, wherein step of finding the first nearest constellation point corresponding to the smallest one of the distances squared and determining the maximum log-likelihood ratio constellation point label according to the first nearest constellation point comprises:
finding the first nearest constellation point corresponding to the smallest one of the distances squared from the first constellation points of the concentric rings; and
determining the maximum log-likelihood ratio constellation point label and a minimum distance squared according to the first nearest constellation point, and adding the maximum log-likelihood ratio constellation point label and the minimum distance squared to a maximum log-likelihood ratio parameter set;
wherein the minimum distance squared is equal to the smallest one of the distances squared.

14. The non-transitory storage medium of claim 13, wherein the amplitude phase shift keying constellation points are M amplitude phase shift keying (M-APSK) constellation points, M is a power of 2, and the iterative search strategy further comprises:
checking the at least one of second nearest constellation point that has at least one bit inverse of the maximum log-likelihood ratio constellation point label in the constellation point labels, and finding the smallest one of the at least one corresponding distance squared between the at least one of second nearest constellation point and the received signal, and adding the smallest one of the at least one corresponding distance squared to the maximum log-likelihood ratio parameter set;
wherein an iteration number of the iterative search strategy is less than or equal to log₂ M.

15. The non-transitory storage medium of claim 14, wherein the first nearest constellation point, the smallest one of the distances squared, the maximum log-likelihood ratio constellation point label, the at least one of second nearest constellation point, the smallest one of the at least one corresponding distance squared, the maximum log-likelihood ratio parameter set and the log-likelihood ratio are applied to a soft-output M-APSK detection of a receiving end to reduce a computational complexity of the soft-output M-APSK detection.
